(19) United States
(12) Patent Application Publication
(10) Pub. No.: US 2013/0103762 A1
(43) Pub. Date: Apr. 25, 2013

(54) Resume Robotically Builds the Network

(71) Applicant: JobDiva, Inc., New York, NY (US)

(72) Inventor: Diya B. Obeid, New York, NY (US)

(73) Assignee: JOBDIVA, INC., New York, NY (US)

(21) Appl. No.: 13/659,791

(22) Filed: Oct. 24, 2012

Related U.S. Application Data
(60) Provisional application No. 61/550,880, filed on Oct. 24, 2011.

(51) Int. Cl. G06F 15/16

(52) U.S. Cl. 709/204

(57) ABSTRACT

A method implemented in a server computer that receives a resume for a resume owner, and parses the resume. The method creates a parsed resume that includes an identity of the resume owner, a network identifier for each entity in the resume, and a relationship between the identity of the resume owner and each network identifier. The method identifies one of the network identifiers in the parsed resume that is a shared network identifier. If a known relationship exists between another resume owner and the shared network identifier, the method creates a social network for the shared network identifier with the resume owner and the other resume owner as members. If a social network exists for the shared network identifier with other resume owners as members, the method adds the resume owner as one of the members of the social network.

### BACKGROUND

While the resume is construed as someone's professional biography, list of credentials, record of work experiences as well as a catalog of their contact information, it has never been construed as the basis of someone's social or professional network.

To date, the most prominent people-based network has been the electronic social network. Even though past social networks comprise professional, religious, vocational, avocational, educational, athletic, or other common characteristics, these networks have been created through the massive buildup of identifiably entered data whose purpose is to link people together. Members of the network comprise the nodes of a network. In the past, membership in the network is optional to the invitee. While people might be extremely qualified to belong to a network, their membership is contingent, either on being invited into the network or on their proactive initiative to enroll in the network. Most importantly, in the past, in order to join the network or learn about the network, prospective members have to be alerted of a pre-existing network, or search for such a network. In the past, people define the network that others join.

There is a need for a method and computing system that parses resumes to generate social network designations for the resume owners, and connects resume owners who share a social network designation. The invention robotically generates electronic social networks from resumes.

### BRIEF DESCRIPTION OF THE DRAWINGS

FIG. 1 is a block diagram that illustrates one embodiment of the hardware components of a computing system according to one embodiment of the present invention.

FIG. 2 and FIG. 3 are block diagrams that illustrate, in detail, one embodiment of the hardware components shown in FIG. 1.

FIG. 4, FIG. 5, FIG. 6, FIG. 7, FIG. 10, and FIG. 11 illustrate one embodiment of excerpts from six exemplary resumes input to the computing system shown in FIG. 1.

FIG. 8 is a timeline diagram that illustrates the employment history shown in the resume excerpts of FIG. 4, FIG. 5, FIG. 6, FIG. 7, FIG. 10, and FIG. 11.

FIG. 9 illustrates connections in more than one network that the present invention derives from the input of the four exemplary resumes shown in FIG. 4, FIG. 5, FIG. 6, and FIG. 7 into the computing system shown in FIG. 1.

FIG. 12 illustrates connections in more than one network that the present invention derives from the input of the two exemplary resumes shown in FIG. 10 and FIG. 11 into the computing system shown in FIG. 1.

FIG. 13 is an exemplary bipartite network that the present invention derives from the input of the six exemplary resumes shown in FIG. 4, FIG. 5, FIG. 6, FIG. 7, FIG. 10, and FIG. 11 into the computing system shown in FIG. 1.

FIG. 14 is a flow diagram that illustrates a method according to one embodiment of the present invention.

### DETAILED DESCRIPTION OF THE INVENTION

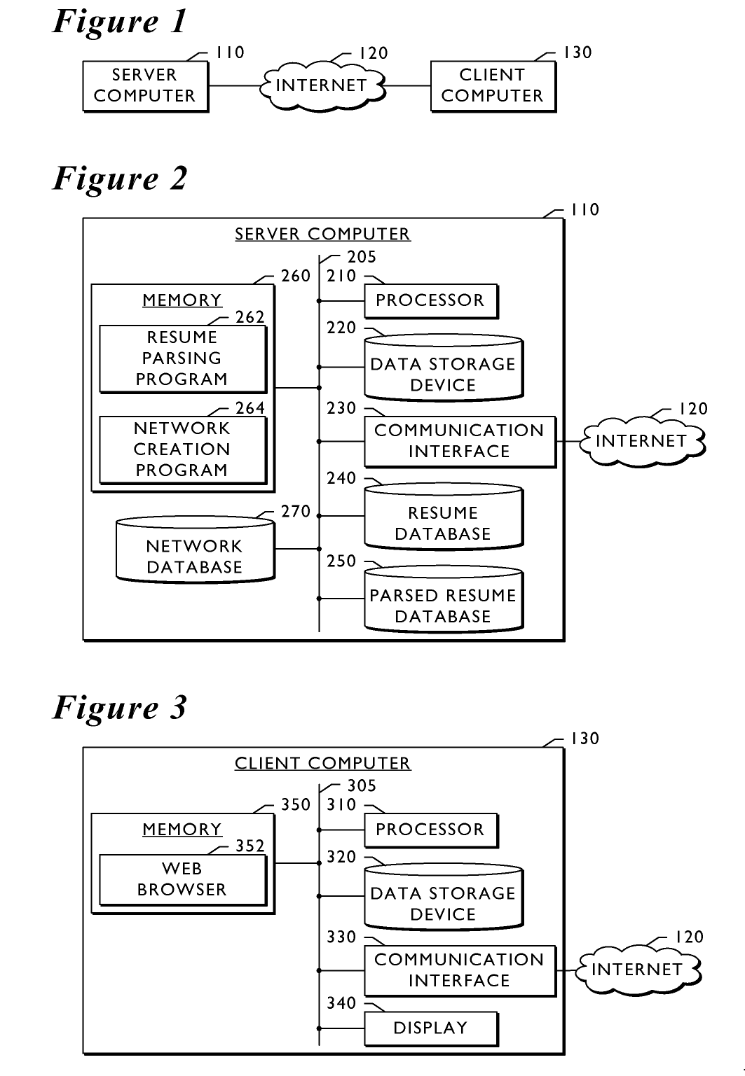

FIG. 1 is a block diagram that illustrates one embodiment of the hardware components of a computing system according to one embodiment of the present invention. FIG. 1 illustrates a client-server architecture, wherein a server computer 110 connects to a client computer 130 via an Internet 120 network. One skilled in the art will understand the client-server architecture shown in FIG. 1 may include any number of interconnected server computer 110, Internet 120, and client computer 130 components.

The Internet 120 shown in FIG. 1, in one embodiment, is a public communication network that connects the server computer 110 to the client computer 130. The present invention also contemplates the use of comparable network architectures including a wide area network (WAN), local area network (LAN), personal area network (PAN) (e.g., a Bluetooth network), wireless LAN (e.g., a wireless-fidelity (Wi-Fi) network), peer-to-peer overlay network, and virtual private network (VPN). The system contemplates comparable network architectures and protocols such as Internet Protocol (IP), Ethernet, and transmission control protocol (TCP/IP).

FIG. 2 is a block diagram that illustrates, in detail, one embodiment of the hardware components shown in FIG. 1. As shown in FIG. 2, the server computer 110 is a general-purpose server computer. A bus 205 is a communication medium connecting a processor 210, data storage device 220, communication interface 230, resume database 240, parsed resume database 250, network database 270, and memory 260. Even though the server computer 110 shown in FIG. 2 includes a single processor 210, one skilled in the art will understand that the server computer 110 may include a number of processors 210 to improve the speed and efficiency of the server computer 110. In various embodiments, the data storage device 220 is a serial ATA (SATA) hard disk drive, optical drive, small computer system interface (SCSI) disk, flash memory, or the like. The communication interface 230 connects the server computer 110 to the Internet 120 and allows for two-way communication of data and content. In various embodiments, the memory 260 is random access memory (RAM), dynamic RAM (DRAM), non-volatile computer memory, flash memory, or the like.

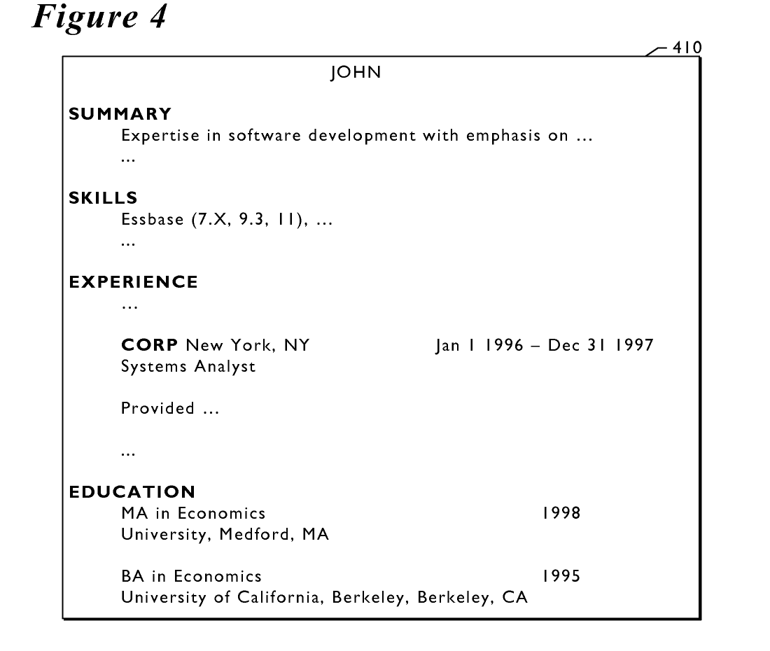

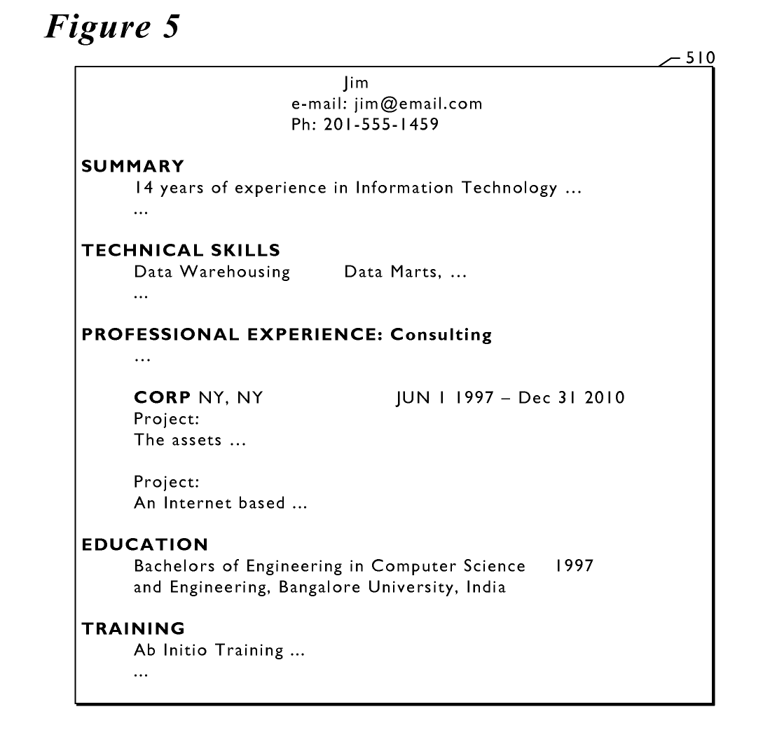

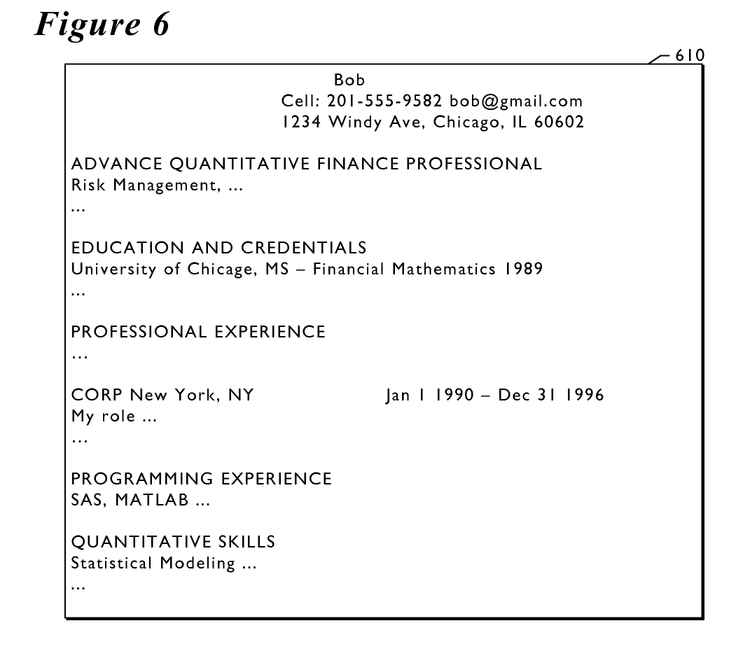

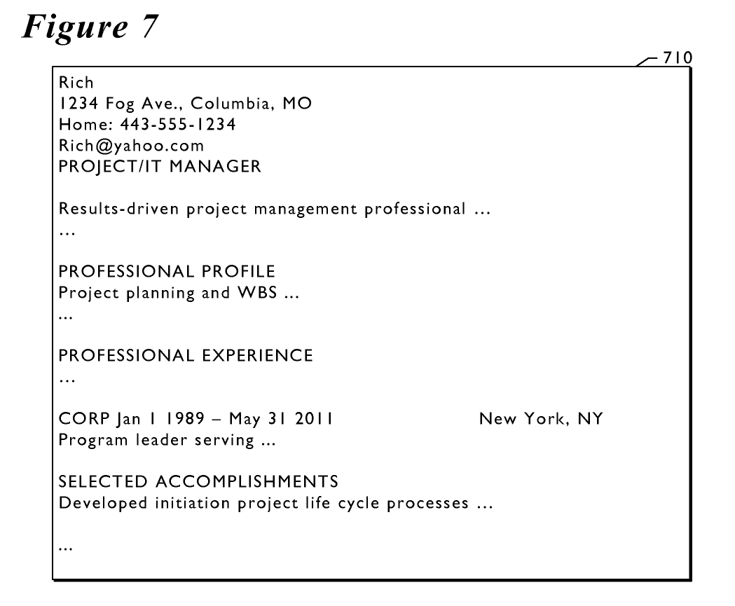

The processor 210 of the server computer 110 performs the disclosed methods by executing sequences of operational instructions that comprise each computer program resident in, or operative on, the memory 260. The reader should understand that the memory 260 may include operating system, administrative, and database programs that support the programs disclosed in this application. In one embodiment, the configuration of the memory 260 of the server computer 110 includes a resume parsing program 262 and network creation program 264. The resume parsing program 262 and network creation program 264 perform the method disclosed in the exemplary embodiments depicted in FIGS. 4, 5, 6, 7, 8, 9, 10, 11, 12, 13, and 14. When the processor 210 performs the disclosed method, it stores intermediate results in the memory 260 or data storage device 220. In another embodiment, the processor 210 may swap these programs, or portions thereof, in and out of the memory 260 as needed, and thus may include fewer than all of these programs at any one time.

FIG. 3 is a block diagram that illustrates, in detail, one embodiment of the hardware components shown in FIG. 1. As shown in FIG. 3, the client computer 130 is a general-purpose computer. A bus 305 is a communication medium connecting a processor 310, data storage device 320, communication interface 330, display 340, and memory 350. Even though the client computer 130 shown in FIG. 3 includes a single processor 310, one skilled in the art will understand that the client computer 130 may include a number of processors 310 to improve the speed and efficiency of the client computer 130. In various embodiments, the data storage device 320 is a serial ATA (SATA) hard disk drive, optical drive, small computer system interface (SCSI) disk, flash memory, or the like. The communication interface 330 connects the client computer 130 to the Internet 120 and allows for two-way communication of data and content. In various embodiments, the memory 350 is random access memory (RAM), dynamic RAM (DRAM), non-volatile computer memory, flash memory, or the like.

The processor 310 of the client computer 130 performs the disclosed methods by executing sequences of operational instructions that comprise each computer program resident in, or operative on, the memory 350. The reader should understand that the memory 350 may include operating system, administrative, and database programs that support the programs disclosed in this application. In one embodiment, the configuration of the memory 350 of the client computer 130 includes a web browser 352. The web browser 352 performs the method disclosed in the exemplary embodiments depicted in FIGS. 4, 5, 6, 7, 8, 9, 10, 11, 12, 13, and 14. When the processor 310 performs the disclosed method, it stores intermediate results in the memory 350 or data storage device 320. In another embodiment, the processor 310 may swap these programs, or portions thereof, in and out of the memory 350 as needed, and thus may include fewer than all of these programs at any one time.

In one embodiment, the network is a community, comprised of individuals, entities, links, connections and relationships. In another embodiment, a network comprises a link between two individuals or entities. Yet in another embodiment, a network comprises multiple links between pairs of individuals or pairs of entities. In one embodiment, a link is a connection between two individuals, a connection between two entities, or a connection between an individual and an entity. In one embodiment, a connection is a relationship. In one embodiment, a link is a connection. In one embodiment, an individual or an entity is a node. In one embodiment, a node may be a node in two or more connections. In one embodiment, a link or a connection comprises two nodes.

In one embodiment, this invention generates social networks whose members comprise individuals who own resumes. In one embodiment, this invention generates networks whose members comprise entities that are mentioned in the resume. Entities comprise individuals, companies, divisions of companies, addresses, professional associations, industries, titles, roles, tools, and other skill or experience-related phrases.

In one embodiment, entities are associated with time periods that are covered by durations that are mentioned in the resume. In one embodiment, a time period is a point in time. In one embodiment, the beginning and end of a time period are the same.

In one embodiment, the time period starts at a point in time after the beginning of a duration that is referenced in the resume and ends at a point in time before the end of a duration that is referenced in the resume. In one embodiment, the time period is defined by the duration. In one embodiment, duration may generate two or more time periods. In one embodiment, the duration comprises the time period.

In one embodiment, the identity of the resume owner, contact information, experiences, time ranges of experiences, companies, divisions of companies, addresses, professional associations, industries, tools, skills, titles, roles and other experience related entities are robotically parsed from the resume.

In one embodiment, the designation of a network is multidimensional, where each dimension may comprise an individual, a company, a division of a company, an address, a professional association, an industry, a tool, a skill, a title, a role and other experience related terms. In one embodiment, the designation of the network is multidimensional, where each dimension may comprise a time period. In one embodiment, membership in the network is robotically assigned based on robotically generated designations. In one embodiment, membership in the network is contingent on dimensions that designated the network. In one embodiment, all members of a network are connected to each other. In another embodiment, the connection between two members of a network comprises two or more connections; at least one from each member to other members in the network. In another embodiment, a network comprises two separate networks that are connected by commonalities in their designation. In one embodiment, the network is a bipartite network, a set of whose nodes are the designations of the networks referenced in this invention and the other set of nodes are the entities described in this invention. The bipartite network robotically affiliates the designations with the entities utilizing links that connect an entity with a designation. In another embodiment, the network is multipartite with two or more sets of nodes comprising various entities derived from resumes.

In this invention, individuals or entities belong to a network based on their background and experiences that are contained in their resume. In one embodiment the resume is a curriculum vitae. In another embodiment, the resume is a biography. Yet in another embodiment, the resume is a profile completed by a candidate for employment and displayed on a personal or public web site. In one embodiment, this invention extracts data from the individual resumes' work experiences to create the network. In another embodiment, this invention extracts data from the individual resumes to create the network. In another embodiment, participants validate and enrich the entities that are robotically generated from the resume.

In one embodiment, the invention extracts entities comprising the participant's titles, skills, employers, work locations and other experience related terms. In one embodiment, the invention will link the owners of the resumes creating a network based on shared entities.

In one embodiment, the links within the network are robotically assigned. In one embodiment, the links within the network are robotically assigned based on the content of the resume. In one embodiment, the links generate invitations to create other links or accept existing links. In another embodiment, the links are acceptances to invitations. In one embodiment, the links generate invitations to validate existing links. In another embodiment, the links are validations of existing links. In another embodiment, the links are validations of robotically generated links. In another embodiment, the links are validations of electronically generated invitations. In another embodiment, the links are acceptances to invitations.

In one embodiment, the invention associates the entities that are extracted from a resume with time periods covered within the resume. In one embodiment, the invention places the time period, during which the entity is mentioned in the resume, in the designation of the network. In one embodiment, the invention places the resume owner in the designation of the network.

In one embodiment, the designation of the network robotically evolves as more members join the network. In another embodiment, the designation of the network robotically evolves as members drop off the network. In one embodiment, networks may accommodate membership that was robotically generated for a different network.

In one embodiment, networks may splinter into smaller networks, whose common denominator with the original network is all dimensions except for the time period.

In another embodiment, the network generated by this invention accommodates features for manual invitations that enrich the membership of the network. In another embodiment, the network generated by this invention accommodates features for manual enrollment that enriches the membership of the network.

As an example, while two ex-employees of a company may belong to a network whose sole designation is the identity of the ex-employer; this invention would robotically generate other networks based on their common previous employer as well as the time period when they worked for that employer. In one embodiment, belonging to the same network requires employment by the same employer during overlapping time periods. Likewise, when belonging to networks that are generated from someone's association with an organization, school alumni group, club, or the like, additional sub-networks would be time period dependent and would be designated by a combination of the membership to the association over a common period of time.

A network may also be designated as belonging to a company or an association's division, location, title, hierarchical level and more; creating a separate network for each such partition. In one embodiment, the network will be designated by the time period during which the membership belonged to such partition of a company, association, entity or any organization.

In one embodiment, a general-purpose computing device, such as the server computer 110 shown in FIG. 2, receives resumes from people operating a client computing device, such as the client computer 130 shown in FIG. 3. In various embodiments, the resumes are electronic resumes, or printed paper resumes scanned into an electronic format. A resume parsing program 262 processes the resumes to determine the connections between the people and a network creation program 264 builds a variety of networks based on the connections. The resumes may vary in format, including standard business resumes, extensive technical resumes, academic resumes, and curriculum vitae. Regardless of the format, the resume parsing program 262 determines from each resume an identity of the person that the resume describes (i.e., the resume owner), and an employment history that includes the name of each employer and the period of employment.

FIG. 4, FIG. 5, FIG. 6, and FIG. 7 illustrate one embodiment of excerpts from four exemplary resumes input to the computing system shown in FIG. 1.

FIG. 4 is an excerpt from an exemplary resume for JOHN 410. As shown in FIG. 4, the resume owner is JOHN who lists under an EXPERIENCE heading in his resume, employment at “CORP New York, N.Y.” from “Jan. 1, 1996-Dec. 31, 1997” as a Systems Analyst.

FIG. 5 is an excerpt from an exemplary resume for Jim 510. As shown in FIG. 5, the resume owner is Jim who lists under a PROFESSIONAL EXPERIENCE: Consulting heading in his resume, employment at “CORP NY, NY” from “Jun. 1, 1997-Dec. 31, 2010” on a variety of Projects.

FIG. 6 is an excerpt from an exemplary resume for Bob 610. As shown in FIG. 6, the resume owner is Bob who lists under a PROFESSIONAL EXPERIENCE heading in his resume, employment at “CORP New York, N.Y.” from “Jan. 1, 1990-Dec. 31, 1996” and describes his role.

FIG. 7 is an excerpt from an exemplary resume for Rich 710. As shown in FIG. 7, the resume owner is Rich who lists under a PROFESSIONAL EXPERIENCE heading in his resume, employment at “CORP” from “Jan. 1, 1989-May 31, 2011” in “New York, N.Y.” as a Program leader.

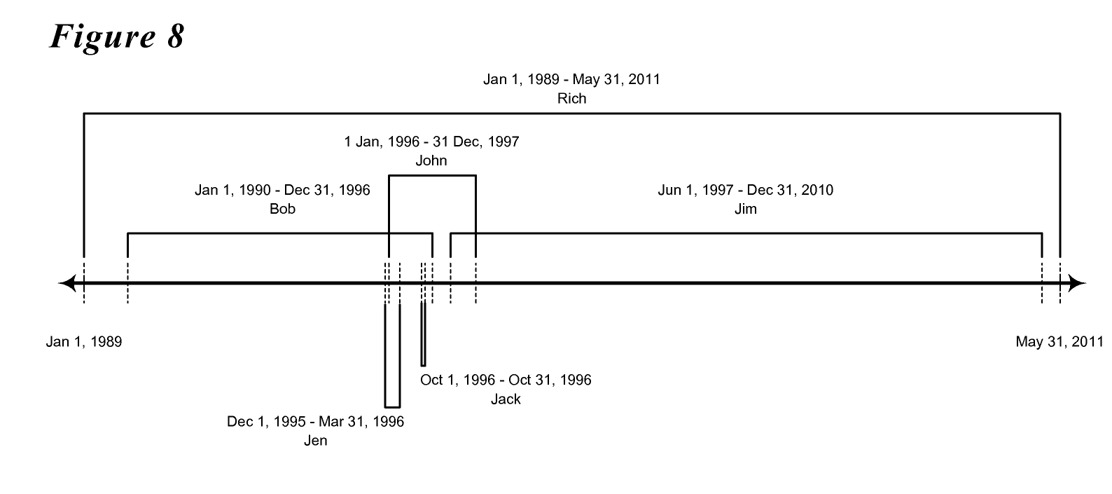

FIG. 8 is a timeline diagram that illustrates the employment history shown in the resume excerpts of FIG. 4, FIG. 5, FIG. 6, and FIG. 7. The timeline shown in FIG. 8 covers the period of time from Jan. 1, 1989 through May 31, 2011. The brackets shown above the timeline in FIG. 8, illustrate the tenure of employment at CORP derived from parsing the resume for John 410, Jim 510, Bob 610, and Rich 710, and show how the time periods for their employment overlap. As shown in FIG. 8, John 410 worked at CORP between Jan. 1, 1996 and Dec. 31, 1997, Jim worked at CORP between Jun. 1, 1997 and Dec. 31, 2010, Bob worked at CORP between Jan. 1, 1990 and Dec. 31, 1996, and Rich worked at CORP between Jan. 1, 1989 and May 31 2011.

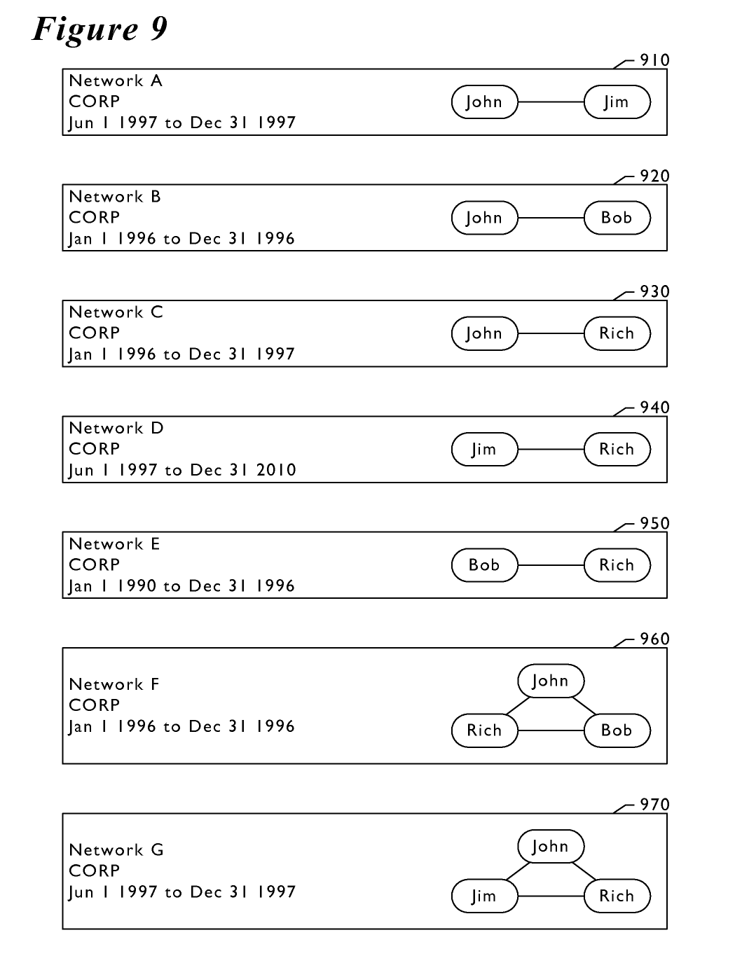

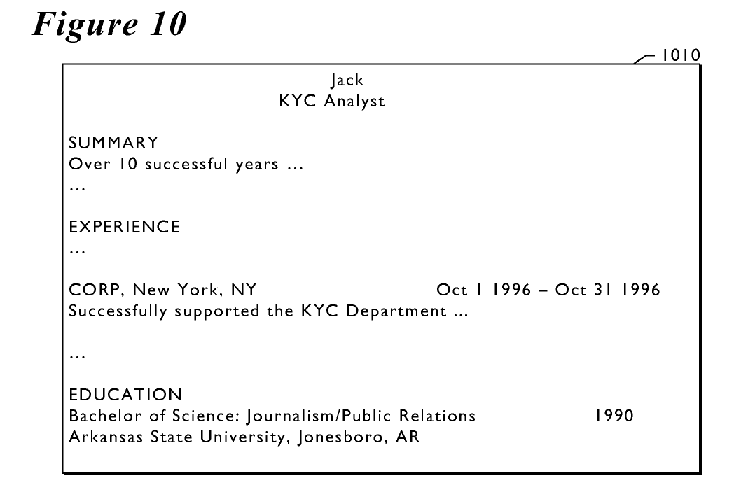

After the server computer 110 parses the resumes for John 410, Jim 510, Bob 610, and Rich 710, the network creation program 264 robotically creates a number of networks based on the overlaps in the time periods. FIG. 9 illustrates connections in more than one network that the present invention derives from the input of the four exemplary resumes shown in FIG. 4, FIG. 5, FIG. 6, and FIG. 7 into the computing system shown in FIG. 1. The network creation program 264 derives the following networks after parsing the exemplary resumes shown in FIG. 4, FIG. 5, FIG. 6, and FIG. 7.

Network A 910 connects John to Jim because their work history at CORP overlaps in a network with a designation that is “Network A, CORP, Jun. 1, 1997 to Dec. 31, 1997”.

Network B 920 connects John to Bob in a network with a designation that is “Network B, CORP, Jan. 1, 1996 to Dec. 31, 1996”.

Network C 930 connects John to Rich because their work history at CORP overlaps in a network with a designation that is “Network C, CORP, Jan. 1, 1996 to Dec. 31, 1997”.

Network D 940 connects Jim to Rich because their work history at CORP overlaps in a network with a designation that is “Network D, CORP, Jun. 1, 1997 to Dec. 31, 2010”.

Network E 950 connects Bob to Rich because their work history at CORP overlaps in a network with a designation that is “Network E, CORP, Jan. 1, 1990 to Dec. 31, 1996”.

Network A 910, Network B 920, Network C 930, Network D 940, and Network E 950 are each two-node, one-link networks. In addition, when the server computer 110 parses the resumes shown in FIG. 4, FIG. 5, FIG. 6, and FIG. 7, the network creation program 264 also derives the following three-node, three-link networks.

Network F 960 connects John, Rich, and Bob because their work history at CORP overlaps in a network with a designation that is “Network F, CORP, Jan. 1, 1996 to Dec. 31, 1996”.

Network G 970 connects John, Jim, and Rich because their work history at CORP overlaps in a network with a designation that is “Network G, CORP, Jun. 1, 1997 to Dec. 31, 1997”.

FIG. 10 and FIG. 11 illustrate one embodiment of excerpts from two additional exemplary resumes input to the computing system shown in FIG. 1.

FIG. 10 is an excerpt from an exemplary resume for Jack 1010. As shown in FIG. 10, the resume owner is Jack, a KYC Analyst, who lists under an EXPERIENCE heading in his resume, employment at “CORP New York, N.Y.” from “Oct. 1, 1996-Oct. 31, 1996”.

FIG. 11 is an excerpt from an exemplary resume for Jen 1110. As shown in FIG. 11, the resume owner is Jen who lists under an Employment heading in her resume, employment from “Dec. 1, 1995-Mar. 31, 1996” at “CORP New York, N.Y.”.

Referring again to FIG. 8, the brackets shown below the timeline, illustrate the tenure of employment at CORP derived from parsing the resume for Jack 1010 and Jen 1110, and show how the time periods for their employment overlap with each other and the time periods for the employment of John 410, Jim 510, Bob 610, and Rich 710. As shown in FIG. 8, Jack 1010 worked at CORP between Oct. 1, 1996 and Oct. 31, 1996, and Jen worked at CORP between Dec. 1, 1995 and May 31, 1996.

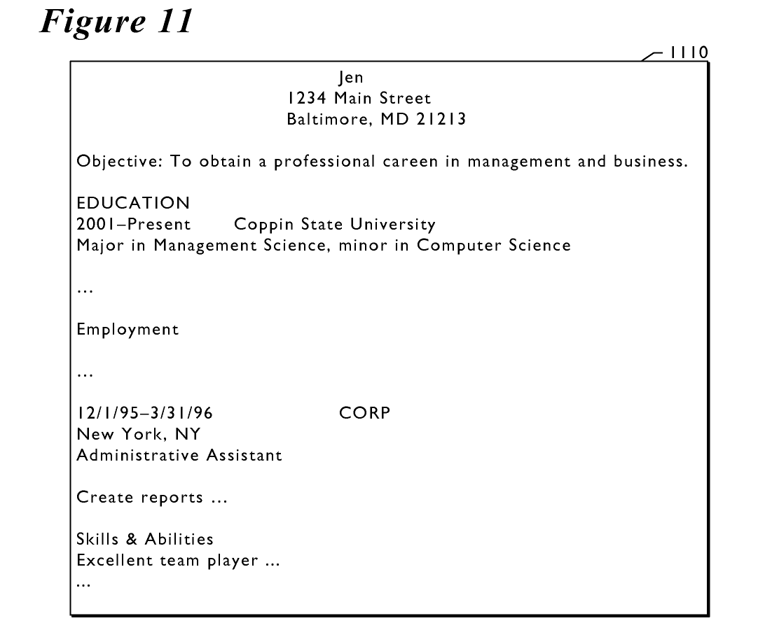

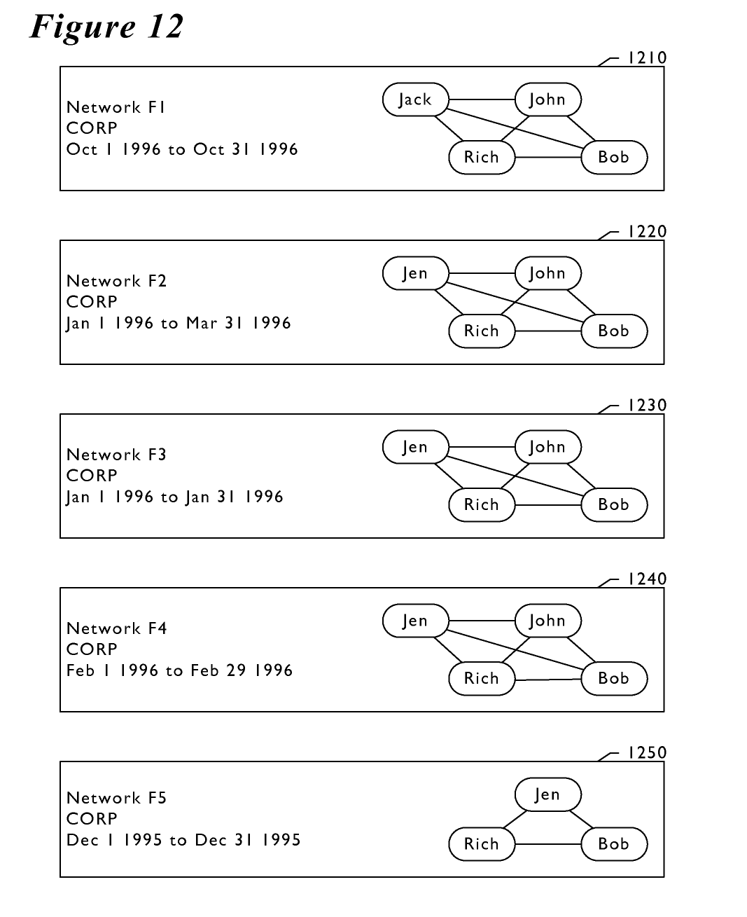

After the server computer 110 parses the resumes for Jack 1010 and Jen 1110, the network creation program 264 robotically creates a number of networks based on the overlaps in the time periods with the resumes of John 410, Jim 510, Bob 610, and Rich 710. FIG. 12 illustrates connections in more than one network that the present invention derives from the input of the two additional exemplary resumes shown in FIG. 10 and FIG. 11 into the computing system shown in FIG. 1. The network creation program 264 derives the following networks after parsing the exemplary resumes shown in FIG. 10 and FIG. 11.

Since Jack worked at CORP between Oct. 1, 1996 and Oct. 31, 1996, Jack's employment history will add three links to Network F 960 shown in FIG. 9. Network F1 1210 connects Jack to each of John, Bob, and Rich because their work history at CORP overlaps in a network with a designation that is “Network F1, CORP, Oct. 1, 1996 to Oct. 31, 1996”. Since Network F1 1210 is a time period dependent network designation, Jack does not connect to Jim.

Since Jen worked at CORP between Dec. 1, 1995 and Mar. 31, 1996, Jen's employment history will add three links to Network F 960 shown in FIG. 9. Network F2 1220 connects Jen to each of John, Bob, and Rich because their work history at CORP overlaps in a network with a designation that is “Network F2, CORP, Jan. 1, 1996 to Mar. 31, 1996”.

Network F3 1230 connects Jen to each of John, Bob, and Rich because their work history at CORP overlaps in a network with a designation that is “Network F3, CORP, Jan. 1, 1996 to Jan. 31, 1996”.

Network F4 1240 connects Jen to each of John, Bob, and Rich because their work history at CORP overlaps in a network with a designation that is “Network F4, CORP, Feb. 1, 1996 to Feb. 29, 1996”.

Each robotically generated and designated network that the present invention derives may have a superset network. Network F3 1230 shown in FIG. 12, and Network F4 1240 shown in FIG. 12, are supersets of Network F2 1220 because the time period for Network F3 1230 is a subset of the time period for Network F2 1220, and the time period for Network F4 1240 is a subset of the time period for Network F2 1220. In one embodiment Network F3 1230 and Network F4 1240 have a larger number of members than Network F2 1220. In one embodiment every member of Network F2 1220 is a member of Network F3 1230. In one embodiment every member of Network F2 1220 is a member of Network F4 1240.

Network F5 1250 connects Jen, Rich, and Bob because their work history at CORP overlaps in a network with a designation that is “Network F5, CORP, Dec. 1, 1995 to Dec. 31, 1995”.

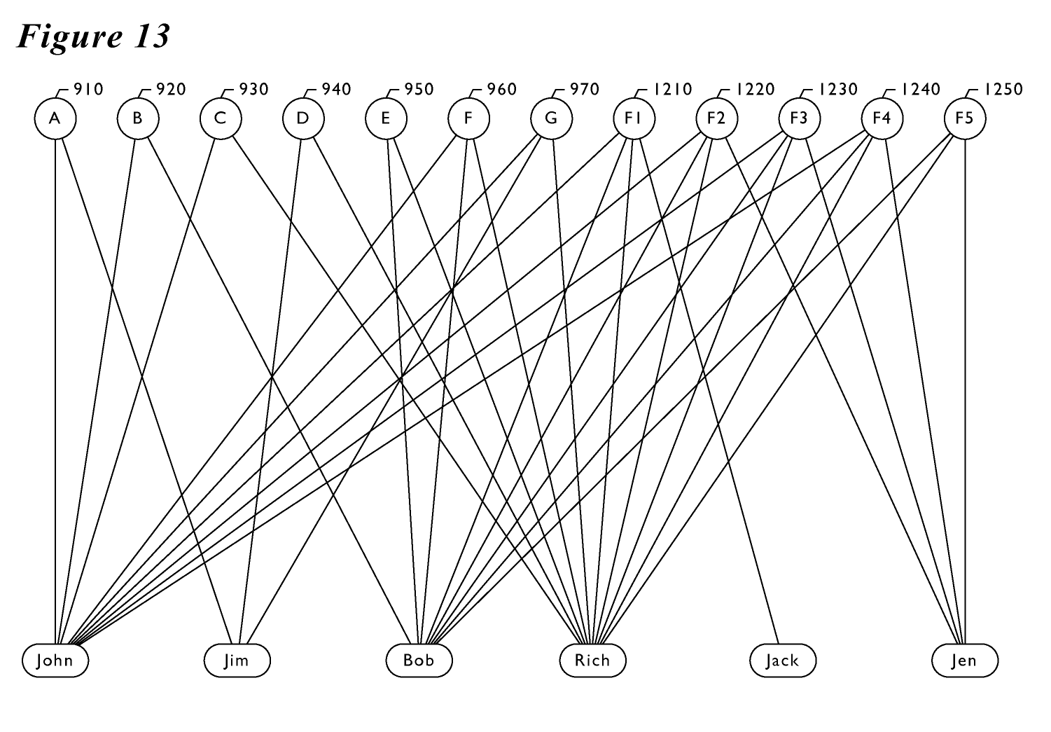

FIG. 13 an exemplary bipartite network that the present invention derives from the input of the six exemplary resumes shown in FIG. 4, FIG. 5, FIG. 6, FIG. 7, FIG. 10, and FIG. 11 into the computing system shown in FIG. 1. One set of nodes shown in FIG. 13 are the two dimensional network with a designation of CORP (i.e., company name) and a date range shown as Network A 910, Network B 920, Network C 930, Network D 940, Network E 950, Network F 960, and Network G 970 as shown in FIG. 9, and Network F1 1210, Network F2 1220, Network F3 1230, Network F4 1240, and Network F5 1250 as shown in FIG. 12. A second set of nodes in the bipartite network shown in FIG. 13 are the resume owners John, Jim, Bob, Rich, Jack, and Jen. In another embodiment, the second set of nodes comprises entities that are derived from the resumes of John, Jim, Bob, Rich, Jack, and Jen.

In one embodiment, a network includes other networks that are inherited. For example, a network designation that comprises the time period Dec. 1, 1995 to Dec. 31, 1995 would also include other networks that are inherited, such as a network designation for the time period Dec. 1, 1995 to Dec. 15, 1995, a network designation for the time period Dec. 15, 1995 to Dec. 20, 1995, or a network designation for the time period Dec. 15, 1995 to Dec. 31, 1995.

The present invention is a network that is being robotically designated from the experiences described in a resume. The present invention is also a network that is being designated by a combination of a sub-designation and a time period.

In the present invention, the membership of the network is electronically based on the shared entity and the time period. In another embodiment, the electronic membership predates an invitation. In yet another embodiment, the electronic links predate invitations. In yet another embodiment, the acceptance of a membership invitation creates a link in a network.

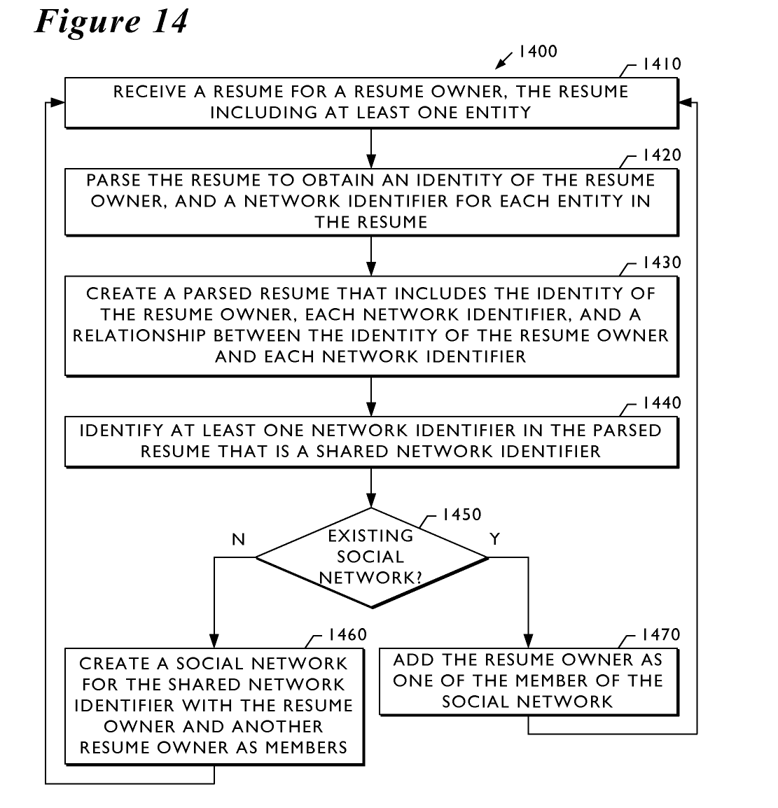

FIG. 14 is a flow diagram that illustrates a method according to one embodiment of the present invention. The process 1400 shown in FIG. 14, with reference to FIGS. 1, 2, and 3, begins when the server computer 110 receives a resume for a resume owner, where the text in the resume includes entities (step 1410). In one embodiment, the resume parsing program 262 stores the resume in the resume database 240. The resume parsing program 262 parses the resume to obtain an identity of the resume owner, and a network identifier for each entity in the resume (step 1420). In one embodiment, the resume parsing program 262 obtains the identity of the resume owner by locating a name and contact information (e.g., postal address, e-mail address, and phone number) for the resume owner in the resume, and extracting the name and contact information. In another embodiment, the resume parsing program 262 obtains the network identifier by locating a name for each entity and determining a start date and end date for the relationship between the resume owner and the entity from the context of the entity in the resume. The resume parsing program 262 creates a parsed resume that includes the identity of the resume owner, each network identifier, and a relationship between the identity of the resume owner and each network identifier (step 1430). In one embodiment, the resume parsing program 262 stores the parsed resume in the parsed resume database 250. The network creation program 264 then identifies at least one network identifier in the parsed resume that is a shared network identifier (step 1440). In one embodiment, a network identifier is a shared network identifier when the resume owner and another resume owner both include the same network identifier in their resume. In another embodiment, a network identifier is a shared network identifier when the time period of the network identifier for the resume owner overlaps with the time period of the network identifier for the other resume owner. The network creation program 264 accesses the network database 270 to determine whether there is an existing social network associated with the shared network identifier (step 1450). If a social network does not exist for the shared network identifier (step 1450, N branch), the network creation program 264 creates a social network for the shared network identifier with the resume owner and the other resume owner as members (step 1460), updates the network database 270, and repeats the process 1400 by receiving another resume (step 1410). In one embodiment, the network creation program 264 sends an invitation to the other resume owner to request creation of the social network with the resume owner, and creates the social network after it receives an acceptance of the invitation from the other resume owner. If a social network exists for the shared network identifier (step 1450, Y branch), the network creation program 264 adds the resume owner as one of the members of the social network (step 1470), updates the network database 270, and repeats the process 1400 by receiving another resume (step 1410). In one embodiment, the network creation program 264 sends an invitation to each other resume owner to request creation of a link to the resume owner, and adds the resume owner to the social network after it receives an acceptance of the invitation from each other resume owner. In yet another embodiment, the network creation program 264 automatically adds the resume owner to the social network and creates a link between the resume owner and each other resume owner.

Although the disclosed embodiments describe a fully functioning method and computing system that parses resumes to generate social network designations for the resume owners, and connects resume owners who share a social network designation, the reader should understand that other equivalent embodiments exist. Since numerous modifications and variations will occur to those reviewing this disclosure, the method and computing system that parses resumes to generate social network designations for the resume owners, and connects resume owners who share a social network designation is not limited to the exact construction and operation illustrated and disclosed. Accordingly, this disclosure intends all suitable modifications and equivalents to fall within the scope of the claims.

1. A method implemented on a server computer system, comprising:
receiving a resume for a resume owner, the resume including at least one entity;
parsing the resume to obtain an identity of the resume owner, and a network identifier for each entity in the resume;
creating a parsed resume that includes the identity of the resume owner, each network identifier, and a relationship between the identity of the resume owner and each network identifier;
identifying at least one network identifier in the parsed resume that is a shared network identifier, wherein a known relationship exists between another resume owner and the shared network identifier; and
creating a social network for the shared network identifier, wherein members of the social network include the resume owner and the other resume owner.

2. The method of claim 1, wherein the receiving of the resume further comprises:
receiving the resume in an electronic format; and
storing the resume,
wherein the resume is at least one of a professional biography, a curriculum vitae, and a profile completed by a candidate for employment and displayed on a personal or public web site.

3. The method of claim 1, wherein each entity is at least one of an individual, a company, a division of a company, a location of a company, an address, a professional association, an industry, a title, a role, a tool, and a skill or experience related phrase.

4. The method of claim 1, wherein the parsing of the resume further comprises:
obtaining a name of the resume owner;
obtaining contact information for the resume owner;
obtaining a name for each entity in the resume;
analyzing the resume to determine, for each entity, a time period of a relationship between the resume owner and the entity, the time period having a start time and an end time; and
wherein the identity of the resume owner includes the name of the resume owner, and the contact information for the resume owner, and
wherein the network identifier for each entity includes the name for the entity, and the time period of the relationship between the resume owner and the entity.

5. The method of claim 1, wherein the creating of the social network further comprises:
sending an invitation to the other resume owner to request creation of the social network with the resume owner; and
receiving an acceptance of the invitation from the other resume owner.

6. A computing device, comprising:
a memory device resident in the computing device; and
a processor disposed in communication with the communication interface and the memory device, the processor configured to:
receive a resume for a resume owner, the resume including at least one entity;
parse the resume to obtain an identity of the resume owner, and a network identifier for each entity in the resume;
create a parsed resume that includes the identity of the resume owner, each network identifier, and a relationship between the identity of the resume owner and each network identifier;
identify at least one network identifier in the parsed resume that is a shared network identifier, wherein a known relationship exists between another resume owner and the shared network identifier; and
create a social network for the shared network identifier, wherein members of the social network include the resume owner and the other resume owner.

7. The computing device of claim 6, wherein to receive the resume, the processor is further configured to:
receive the resume in an electronic format; and
store the resume,
wherein the resume is at least one of a professional biography, a curriculum vitae, and a profile completed by a candidate for employment and displayed on a personal or public web site.

8. The computing device of claim 6, wherein each entity is at least one of an individual, a company, a division of a company, a location of a company, an address, a professional association, an industry, a title, a role, a tool, and a skill or experience related phrase.

9. The computing device of claim 6, wherein to parse the resume, the processor is further configured to: obtain a name of the resume owner;
obtain contact information for the resume owner;
obtain a name for each entity in the resume;
analyze the resume to determine, for each entity, a time period of a relationship between the resume owner and the entity, the time period having a start time and an end time,
wherein the identity of the resume owner includes the name of the resume owner, and the contact information for the resume owner, and
wherein the network identifier for each entity includes the name for the entity, and the time period of the relationship between the resume owner and the entity.

10. The computing device of claim 6, wherein to create the social network, the processor is further configured to:
send an invitation to the other resume owner to request creation of the social network with the resume owner; and
receive an acceptance of the invitation from the other resume owner.

11. A method implemented on a server computer system, comprising:
receiving a resume for a resume owner, the resume including at least one entity;
parsing the resume to obtain an identity of the resume owner, and a network identifier for each entity in the resume;
creating a parsed resume that includes the identity of the resume owner, each network identifier, and a relationship between the identity of the resume owner and each network identifier;
identifying at least one network identifier in the parsed resume that is a shared network identifier, wherein a social network exists for the shared network identifier, and wherein members of the social network include other resume owners; and adding the resume owner as one of the members of the social network.

12. The method of claim 11, wherein the receiving of the resume further comprises:
receiving the resume in an electronic format; and
storing the resume,
wherein the resume is at least one of a professional biography, a curriculum vitae, and a profile completed by a candidate for employment and displayed on a personal or public web site.

13. The method of claim 11, wherein each entity is at least one of an individual, a company, a division of a company, a location of a company, an address, a professional association, an industry, a title, a role, a tool, and a skill or experience related phrase.

14. The method of claim 11, wherein the parsing of the resume further comprises:
obtaining a name of the resume owner;
obtaining contact information for the resume owner;
obtaining a name for each entity in the resume;
analyzing the resume, for each entity, to determine a time period of a relationship between the resume owner and the entity, the time period having a start time and an end time,
wherein the identity of the resume owner includes the name of the resume owner, and the contact information for the resume owner, and
wherein the network identifier for each entity includes the name for the entity, and the time period of the relationship between the resume owner and the entity.

15. The method of claim 11, wherein the adding of the resume owner to the social network further comprises:
sending an invitation to each other resume owner to request creation of a link to the resume owner; and
receiving an acceptance of the invitation from each other resume owner.

16. The method of claim 11, wherein the adding of the resume owner to the social network further comprises:
creating a link between the resume owner and each other resume owner.

17. A computing device, comprising:
a memory device resident in the computing device; and
a processor disposed in communication with the communication interface and the memory device, the processor configured to:
receive a resume for a resume owner, the resume including at least one entity;
parse the resume to obtain an identity of the resume owner, and a network identifier for each entity in the resume;
create a parsed resume that includes the identity of the resume owner, each network identifier, and a relationship between the identity of the resume owner and each network identifier;
identify at least one network identifier in the parsed resume that is a shared network identifier, wherein a known relationship exists between another resume owner and the shared network identifier; and
create a social network for the shared network identifier, wherein members of the social network include the resume owner and the other resume owner.

18. The computing device of claim 17, wherein to receive the resume, the processor is further configured to:
receive the resume in an electronic format; and
store the resume,
wherein the resume is at least one of a professional biography, a curriculum vitae, and a profile completed by a candidate for employment and displayed on a personal or public web site.

19. The computing device of claim 17, wherein each entity is at least one of an individual, a company, a division of a company, a location of a company, an address, a professional association, an industry, a title, a role, a tool, and a skill or experience related phrase.

20. The computing device of claim 17, wherein to parse the resume, the processor is further configured to:
obtain a name of the resume owner;
obtain contact information for the resume owner;
obtain a name for each entity in the resume;
analyze the resume to determine, for each entity, a time period of a relationship between the resume owner and the entity, the time period having a start time and an end time,
wherein the identity of the resume owner includes the name of the resume owner, and the contact information for the resume owner, and
wherein the network identifier for each entity includes the name for the entity, and the time period of the relationship between the resume owner and the entity.

21. The computing device of claim 17, wherein to add the resume owner to the social network, the processor is further configured to:
send an invitation to each other resume owner to request creation of a link to the resume owner; and
receive an acceptance of the invitation from each other resume owner.

22. The computing device of claim 17, wherein to add the resume owner to the social network, the processor is further configured to:
create a link between the resume owner and each other resume owner.
